(19) United States
(12) Patent Application Publication
(10) Pub. No.: US 2010/0161413 A1
(43) Pub. Date: Jun. 24, 2010

(54) VIRTUAL UNIVERSE EXCHANGES BASED ON REAL-WORLD TRANSACTIONS

(75) Inventors: Jeffrey D. Amsterdam, Marietta, GA (US); Rick A. Hamilton, II, Charlottesville, VA (US); Brian M. O'Connell, Cary, NC (US); Clifford A. Pickover, Yorktown Heights, NY (US); Keith R. Walker, Austin, TX (US)

Correspondence Address: Keohane & D'Alessandro, 1881 Western Avenue Suite 180, Albany, NY, 12203, US

(73) Assignee: International Business Machines Corporation, Armonk, NY (US)

(21) Appl. No.: 12/338,734

(22) Filed: Dec. 18, 2008

(51) Int. Cl. G06Q 30/00

(52) U.S. Cl. 705/14.49

(57) ABSTRACT

An invention that establishes a virtual universe benefit based on a real-world transaction is provided. In one embodiment, there is a benefit establishing tool, including a linking component configured to link a user of a virtual universe with a business entity. The benefit establishing tool further includes a benefit component configured to establish a virtual universe benefit to the user based on a real-world transaction between the user and the business entity.

### FIELD OF THE INVENTION

This invention relates generally to virtual universes and more specifically to the correlation of virtual universe benefits with real-world transactions.

### BACKGROUND OF THE INVENTION

The ability to categorize credit card purchases and link purchases to reward or other affinity programs is well known in the credit card industry. For example, some credit card companies automatically categorize merchant type and/or purchases such that when the credit card company's card is used with a compatible merchant, the purchases may be categorized at the merchant and/or item level. However, the prior art does not extend to the virtual world.

### SUMMARY OF THE INVENTION

In one embodiment, there is a method for establishing a virtual universe benefit based on a real-world transaction. In this embodiment, the method comprises: linking a user of a virtual universe with a business entity, and establishing a virtual universe benefit to the user based on a real-world transaction between the user and the business entity.

In a second embodiment, there is a computer system for establishing a virtual universe benefit based on a real-world transaction. In this embodiment, the system comprises at least one processing unit and memory operably associated with the at least one processing unit. A benefit establishing tool is storable in memory and executable by the at least one processing unit. The benefit establishing tool comprises a linking component configured to link a user of a virtual universe with a business entity. A benefit component is configured to establish a virtual universe benefit to the user based on a real-world transaction between the user and the business entity.

In a third embodiment, there is a computer-readable medium storing computer instructions, which when executed, enables a computer system to establish a virtual universe benefit based on a real-world transaction. In this embodiment, the computer instructions comprise: linking a user of a virtual universe with a business entity, and establishing a virtual universe benefit to the user based on a real-world transaction between the user and the business entity.

In a fourth embodiment, there is a method for deploying a benefit establishing tool for use in a computer system that establishes a virtual universe benefit based on a real-world transaction. In this embodiment, a computer infrastructure is provided and is operable to: link a user of a virtual universe with a business entity, and establish a virtual universe benefit to the user based on a real-world transaction between the user and the business entity.

### BRIEF DESCRIPTION OF THE DRAWINGS

FIG. 1 shows a high-level schematic diagram showing a networking environment for providing a virtual universe according to one embodiment of this invention;

FIG. 2 shows a more detailed view of the virtual universe client shown in FIG. 1;

FIG. 3 shows a more detailed view of some of the functionalities provided by the server array shown in FIG. 1;

FIG. 4 shows a benefit establishing tool and real-world business entities according to one embodiment of this invention that operates in the environment shown in FIG. 1;

FIG. 5 shows a schematic of an exemplary computing environment in which elements of the networking environment shown in FIG. 1 may operate; and

FIG. 6 shows a flow diagram of a method for establishing a virtual universe benefit based on a real-world transaction according to one embodiment of the invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

Embodiments of this invention are directed to establishing a virtual universe benefit based on a real-world transaction, such that a real-world transaction may be reflected within a virtual universe. In these embodiments, a benefit establishing tool provides the capability to establish a virtual universe benefit based on a real-world transaction. Specifically, the benefit establishing tool comprises a linking component configured to link a user of a virtual universe with a business entity. A benefit component is configured to establish the virtual universe benefit to the user based on the real-world transaction between the user and the business entity.

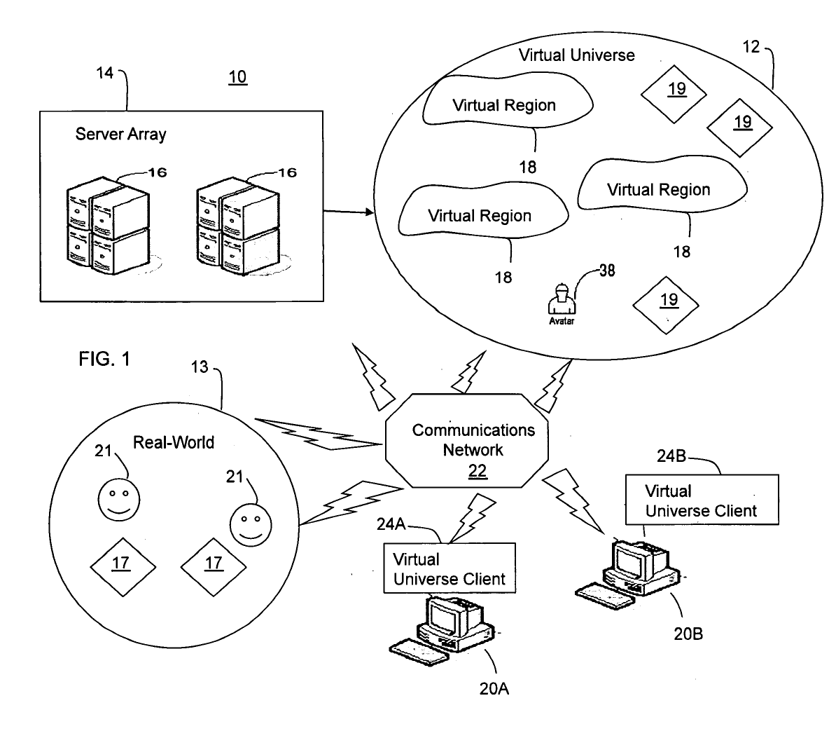

FIG. 1 shows a high-level schematic diagram showing a networking environment 10 for providing a virtual universe 12 according to one embodiment of this invention in which a service for establishing a virtual universe benefit based on a real-world transaction is provided. As shown in FIG. 1, networking environment 10 comprises a server array or grid 14 comprising a plurality of servers 16, each responsible for managing a portion of virtual real estate within virtual universe 12. A virtual universe provided by a multiplayer online game, for example, can employ thousands of servers to manage all of the virtual real estate. The virtual content of the virtual real estate that is managed by each of servers 16 within server array 14 shows up in virtual universe 12 as a virtual region 18 made up of objects, textures and scripts. Like the real-world, each virtual region 18 within virtual universe 12 comprises a landscape having virtual content, such as buildings, clubs, sporting arenas, parks, beaches, cities and towns all created by administrators or residents of the universe that are represented by avatars 38.

Virtual universe 12 may comprise a number of virtual stores 19 for avatars 38 to traverse and shop. Virtual stores 19 may be virtual representations of real-world business entities or they may be unique to virtual universe 12. Virtual stores 19 may represent a wide variety of business entities including, but not limited to: vendors, shops, retailers, service providers, etc. These examples of virtual content are only illustrative of some objects and establishments that may be found in a virtual region and are not limiting. Furthermore, the number of virtual regions 18 shown in FIG. 1 is only for illustration purposes and those skilled in the art will recognize that there may be many more regions found in a typical virtual universe, or even only one region in a small virtual universe. FIG. 1 also shows that users operating computers 20A-20B (hereinafter referred generally as 20) interact with virtual universe 12 through a communications network 22 via virtual universe clients 24A-24B (hereinafter referred generally as 24) that reside in the computers 20, respectively. Below are further details of virtual universe 12, server array 14, and virtual universe client 24.

The networking environment 10 in FIG. 1 further comprises a real-world 13 containing real-world business entities 17 and users 21. Real-world business entities 17 may represent a wide variety of business entities including, but not limited to: credit card companies, vendors, organizations, banks, shops, retailers, debit card providers, service providers or trans-vendor service providers, which aggregate and report purchase activities from a variety of sources. Users 21 in real-world 13 are the same users operating computers 20A-20B, as referred to above, or a person connected to the users (e.g., a family member). Each of users 21 has a corresponding avatar(s) 38, which is a persona or representation of user 21 within the virtual universe. Avatar 38 roams all about virtual region 12 by walking, driving, flying or even by teleportation or transportation, which is essentially moving through space from one point to another, more or less instantaneously. These examples of virtual content and real-world content shown in FIG. 1 are only illustrative of some things that may be found in virtual universe 12 and real-world 13. Those skilled in the art will recognize that these regions can have any number of avatars, users and business entities.

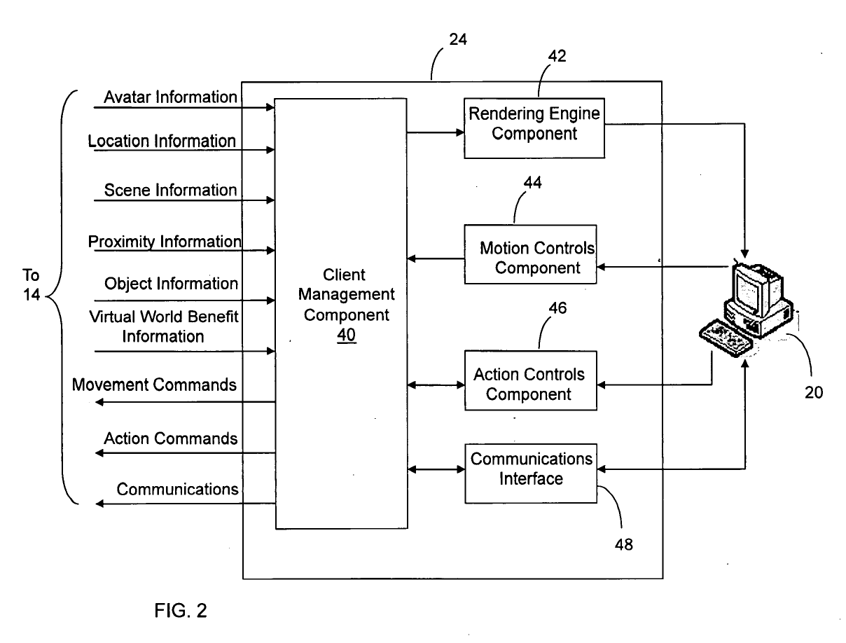

FIG. 2 shows a more detailed view of virtual universe client 24 shown in FIG. 1. Virtual universe client 24, which enables users to interact with virtual universe 12, comprises a client management component 40, which manages actions, movements and communications made by the users through computer 20, and information received from the virtual universe through server array 14. A rendering engine component 42 enables a user to visualize his or her avatar within the surroundings of the particular region of virtual universe 12 that the avatar is presently located.

A motion controls component 44 enables users to control the movements of their avatars through the virtual universe. In one embodiment, movements through the virtual universe can include, for example, gestures, postures, walking, running, driving, flying, etc. An action controls component 46 enables a user to perform actions in the virtual universe such as buying items for his or her avatar or even for their real-life selves, building homes, planting gardens, etc. These actions are only illustrative of some possible actions that a user can perform in the virtual universe and are not limiting. A communications interface 48 enables a user to communicate with other users of virtual universe 12 through modalities such as chatting, instant messaging, gesturing, talking and electronic mail (e-mail). The communications interface 48 also allows avatars to communicate with representatives of virtual stores 19 within virtual universe 12. The representatives may be controlled by people or automated with scripted interaction.

FIG. 2 shows the various types of information received by client management component 40 from the virtual universe through server array 14. Client management component 40 receives avatar information about the avatars that are in proximity to the user's avatar. In addition, client management component 40 receives location information about the area that the user's avatar is near (e.g., what region or land he or she is in), as well as scene information (e.g., what the avatar sees). Client management component 40 also receives proximity information, which contains information on what the user's avatar is near, and object information, which is information about nearby objects in the virtual universe. FIG. 2 shows the movement commands and action commands that are generated by the user and sent to the server array via client management component 40, as well as the communications that can be sent to the users of other avatars within the virtual universe. Client management component 40 also receives virtual universe benefit information, including information about benefits available to users as a result of real-world transactions between the users and the real-world business entities, as will be further described below.

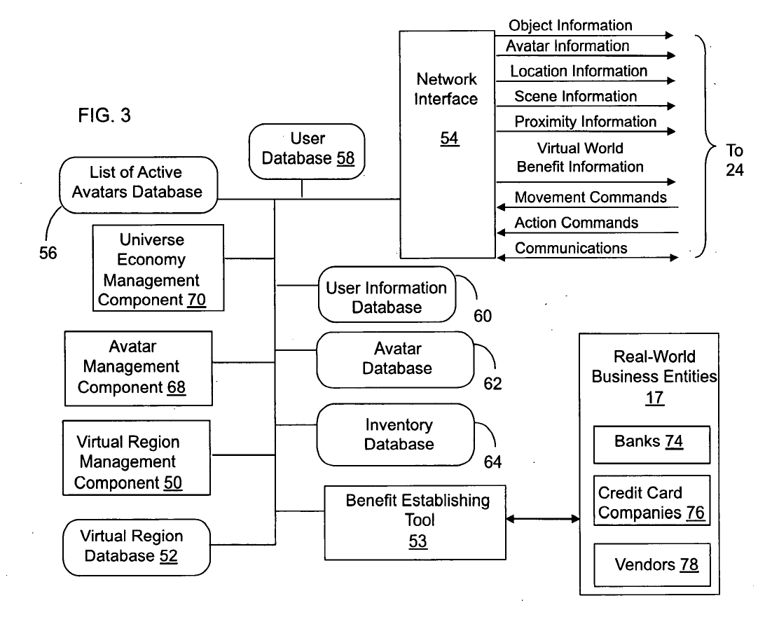

FIG. 3 shows a more detailed view of some of the functionalities provided by server array 14 shown in FIG. 1. In particular, FIG. 3 shows a virtual region management component 50 that manages a virtual region within the virtual universe. Virtual region management component 50 manages what happens in a particular region, such as the type of landscape in that region, the number of homes, commercial zones, virtual stores, streets, parks, restaurants, etc. For example, virtual region management component 50 would allow the owner of a particular region or establishment within the region to specify requirements for accessing or remaining within a restricted region or portion of a region. Those skilled in the art will recognize that virtual region management component 50 can manage many other facets within the virtual region.

FIG. 3 shows a network interface 54 that enables server array 14 to interact with virtual universe client 24 residing on computer 20. In particular, network interface 54 communicates avatar, location, scene, proximity, script, object and virtual universe benefit information to the user through virtual universe client 24. The network interface receives movement and action commands, as well as communications from the user via the universe client.

As shown in FIG. 3, there are several different databases for storing information. In particular, a virtual region database 52 stores information on all of the specifics in each of the virtual regions 18 that virtual region management component 50 is managing. In one embodiment, for very large virtual universes, one server 16 may be responsible for managing one particular virtual region 18 within the universe. In other embodiments, it is possible that one server 16 may be responsible for handling one particular land within the virtual region 18.

Database 56 contains a list of all the avatars that are online in the virtual universe. Databases 58 and 60 contain private and/or public information on the actual human users of the virtual universe. In one embodiment, database 58 contains general information on the users such as names, email addresses, locales, interests, ages, preferences, etc., while database 60 contains more sensitive information on the users such as billing information (e.g., credit card information) for taking part in virtual and/or real-world transactions.

Databases 62 and 64 contain information on the avatars of the users that reside (i.e., the residents) in virtual universe. In one embodiment, database 62 contains information such as all of the avatars that a user may have, the profile of each avatar, and avatar characteristics (e.g., appearance, voice and movement features). Inventory database 64 contains an inventory of items that each avatar owns, include clothing, virtual pets, vehicles, electronic media (e.g., music files), or other possessions. Those skilled in the art will recognize that this listing of inventory items is illustrative of possible items and is not exhaustive. For example, other inventory items may include graphics files, sound files, animations, electronic documents, video files, avatar accessories, avatar body parts, avatar tools or other objects, calling cards, note cards, photos and photo albums, or any other type of item.

Each inventory item may be associated with a piece of executable code or other data, called a script, which may affect rendering in some fashion during a session in the virtual universe. A clothing inventory item, for example, may be rendered with a script that causes the clothing to shimmer. A virtual pet, in another example, may render as an automated avatar that follows the user's avatar within the virtual universe, performing actions typical of a pet, provided a collection of automation scripts are associated with the virtual pet item.

Those skilled in the art will recognize that databases 58-64 may contain additional information, and may be consolidated into a single database or table, divided into multiple database or tables, or clustered into a database system spanning multiple physical and logical devices. Although the above information is shown in FIG. 3 as being stored in databases, those skilled in the art will recognize that other means of storing information can be utilized. For example, inventory database 64 might reside on the same computers as virtual universe client 24, have components that reside on both server array 14 and virtual universe client 24, or reside on separate computers in direct communication with virtual universe servers 16 and virtual universe clients 24.

An avatar management component 68 keeps track of what online avatars are doing while in the virtual universe. For example, avatar management component 68 can track where the avatar presently is in the virtual universe, what activities it is performing or has recently performed. An illustrative but non-exhaustive list of activities can include shopping, eating, talking, recreating, etc.

Because both virtual universes and the real-world have vibrant economies, server array 14 has functionalities configured to manage the economies. Users can take part in real-world transactions with various business entities in the real-world, or conduct commercial transactions via his or her avatar within the virtual universe. In order to fulfill this type of transaction and others similarly related, benefit establishing tool 53 interacts with banks 74, credit card companies 76 and vendors 78, etc.

As shown in FIG. 3, benefit establishing tool 53 resides on the same computer system as server array 14 and communicates directly to the virtual universe and its residents via virtual universe client 24. In other embodiments, benefit establishing tool 53 might reside on the same computers as virtual universe client 24, have components that reside on both server array 14 and virtual universe client 24, or reside on separate computers in direct communication with virtual universe servers 16 and virtual universe clients 24.

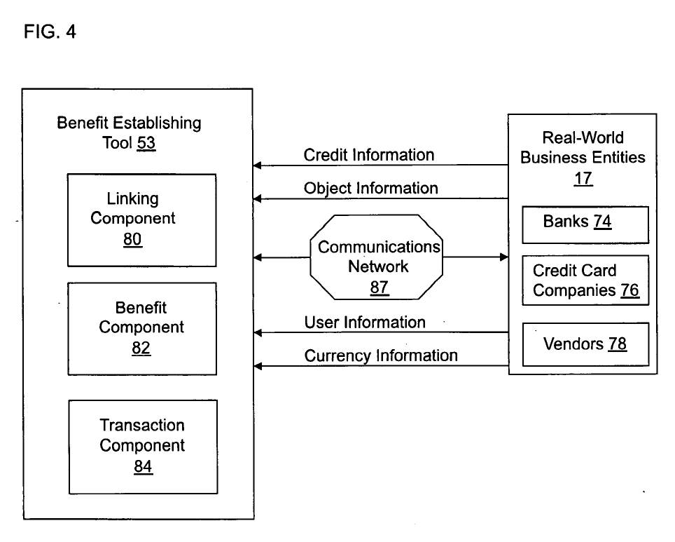

FIG. 4 shows a more detailed view of benefit establishing tool 53 according to embodiments of the present invention. As shown in FIG. 4, benefit establishing tool 53 communicates and exchanges information with real-world business entities 17 to establish virtual universe benefits based on real-world transactions. Benefit establishing tool 53 comprises a linking component 80 configured to link users of the virtual universe with real-world business entities 17. In one embodiment, users may register their virtual universe account with a real-world business entity, such as one of the credit card companies 76, so that real-world transactions made using a credit card issued by the credit card company 76 may be linked to the user's virtual universe account. Once the user registers his/her virtual universe account, real-world transactions or purchases with the linked credit card permit the avatar(s) associated with the users to access a virtual product or service, which may be a virtual representation of the real-world product or service purchased during the transaction. In this embodiment, access to the virtual product or service requires data of the product or service purchased to be sent by the credit card company. In other embodiments where such data is not sent, the real-world business and/or business type may be used to determine the virtual product or service. For example, a real-world transaction at an electronics retailer may be rewarded with a virtual universe electronics item or a choice of items, even if not directly linked to the actual item purchased.

As shown in FIG. 4, benefit establishing tool 53 further comprises a benefit component 82 configured to establish the virtual universe benefit to the user based on the real-world transaction between the user and at least one of business entities 17. In particular, the benefit component 82 performs at least one of the following: adds a virtual product to an inventory of an avatar associated with the user, provides a credit to be redeemed by the avatar within the virtual universe, provides a currency reward to be used by the avatar within the virtual universe, provides an avatar augmentation, provides a message for the user, or provides access to a restricted portion of the virtual universe, such as a building or region in the virtual universe.

In one embodiment, a virtual product, which may be a replica of the real-world product purchased during the real-world transaction, is added to inventory database 64 within the virtual universe. In this way, the virtual product is made available to the avatar the next time the user logs in. However, the virtual universe benefit is not limited to virtual products. In another embodiment, the benefit may be a credit or a currency reward, which can be redeemed by an avatar within the virtual universe. For example, credit card companies may automatically categorize a purchase such that when the credit card company's card is used with a compatible merchant, the purchase generates a redeemable reward. The credit card company may offer a credit or a currency reward to be redeemed at one of the virtual stores within the virtual universe. In another example, a real-world vendor may offer credits towards virtual universe merchandise located in a virtual store also owned and operated by the vendor. Real-world business entities may also provide currency rewards to users, which can essentially be used as cash within the virtual universe to purchase any number of goods or services desired by the user.

In another embodiment, an avatar augmentation is available based on a real-world transaction. For example, if a user purchases a physical fitness device in the real world, the user's virtual universe avatar may be augmented with geometries indicative of increased fitness and strength. In another embodiment, a transaction in the real world may result in a message delivered to the user in the virtual universe. The message may arrive as a user notification, as a message delivered by an automated representative of a virtual store, or as any other message delivered in the virtual universe. For example, the message may contain a thank you message, information about the product or service purchased, a password to access a reward, or any other information beneficial to the user. In another embodiment, a real-world transaction may provide access to a restricted portion of the virtual universe, such as a particular building, region, or group. For example, a transaction with a merchant in the real world may give users access to a user support group in the virtual universe, entry into a club, and/or access to a special building or region otherwise inaccessible or accessible with cost to the user.

As shown in FIG. 4, information necessary for establishing virtual universe benefits based on a real-world transaction is transmitted over a communications network 87. During operation, real-world business entities 17 may send notifications over communications network 87 to the virtual universe via benefit establishing tool 53. In one embodiment, the notification comprises a user identification to identify the user's account. This information may include, but is not limited to, a username, a password, an avatar name, or an avatar universally unique ID (UUID). The virtual universe uses this information to identify the accounts of user(s) entitled to the virtual universe benefit.

If real-world business entities 17 intend to provide users with a virtual product, they may transmit object information identifying the product to the virtual universe. The virtual universe and real-world business entities 17 may agree on a set of possible objects that users may be awarded and assign identifying numbers to each object. In one embodiment, the data may only include the identification number. The virtual universe receives this identification number during processing of the transmitted notification. Alternatively, real-world business entities 17 may transmit the data necessary to construct the object within the virtual universe, or transmit a UUID for an object that pre-exists in the virtual universe as part of the notification message.

If a real-world business entity intends to transfer a credit or a currency reward to the user, information including the type and amount of the credit or currency reward is transmitted to the virtual universe via benefit establishing tool 53. If necessary, the virtual universe is configured to convert the currency reward into the currency of the virtual universe based on a predetermined exchange rate.

The information contained in the notification(s) may be transmitted between real-world business entities 17 and benefit establishing tool 53 in a number of ways. One possible data transmission method includes the use of a secure web service provided by the virtual universe provider that accepts partner notifications. Partners in this process may submit the required data for notifications to this web service on a per transaction or batch transfer basis.

In another embodiment, an online store or an interface to a credit card account may enable a user to personally direct credits from purchases to a particular virtual universe. This type of transaction may be enabled through a secure form application on a web site, which submits data to a virtual universe through a server based process, such as from a Common Gateway Interface (CGI) or web server module to a listener port on the virtual universe server.

In yet another embodiment, data collected by a retailer, credit card company, etc., may be sent to the virtual universe through a simple file transfer protocol (FTP) process. The data may be formatted into a standard file, such as specified by an extensible markup language document type definition (XML DTD) for this specific application, and sent via FTP to the virtual universe.

As also shown in FIG. 4, benefit establishing tool 53 comprises a transaction component 84 configured to charge a benefit fee for establishing virtual universe benefits based on real-world transactions. In this embodiment, the provider of the virtual universe or a third party service provider could offer this as a service by performing the functionalities described herein on a subscription and/or fee basis. In this case, the provider of the virtual universe or the third party service provider can create, deploy, maintain, support, etc., benefit establishing tool 53 that performs the processes described in the invention. In return, the virtual universe or the third party service provider can receive payment from the virtual universe users or the real-world business entities.

The present invention has advantages for multiple parties. For example, virtual universe users may accumulate virtual products the user wants or needs within the virtual universe without the requirement to repurchase or build the virtual product. Virtual universe service providers that implement the present invention have advantages over competing virtual universe service providers since users have an enhanced experience. Service providers also may charge vendors, credit card companies, and/or users a fee. Credit card companies offering this service may implement the proposed invention for a fee or as an incentive for customers to use their product over others. Real-world vendors offering benefits as virtual universe credits may increase revenue through increased traffic, brand awareness, etc.

The methodologies disclosed herein can be used within a computer system to provide virtual universe benefits based on real-world transactions. In this case, benefit establishing tool 53 can be provided, and one or more systems for performing the processes described in the invention can be obtained and deployed to a computer infrastructure. To this extent, the deployment can comprise one or more of (1) installing program code on a computing device, such as a computer system, from a computer-readable medium; (2) adding one or more computing devices to the infrastructure; and (3) incorporating and/or modifying one or more existing systems of the infrastructure to enable the infrastructure to perform the process actions of the invention.

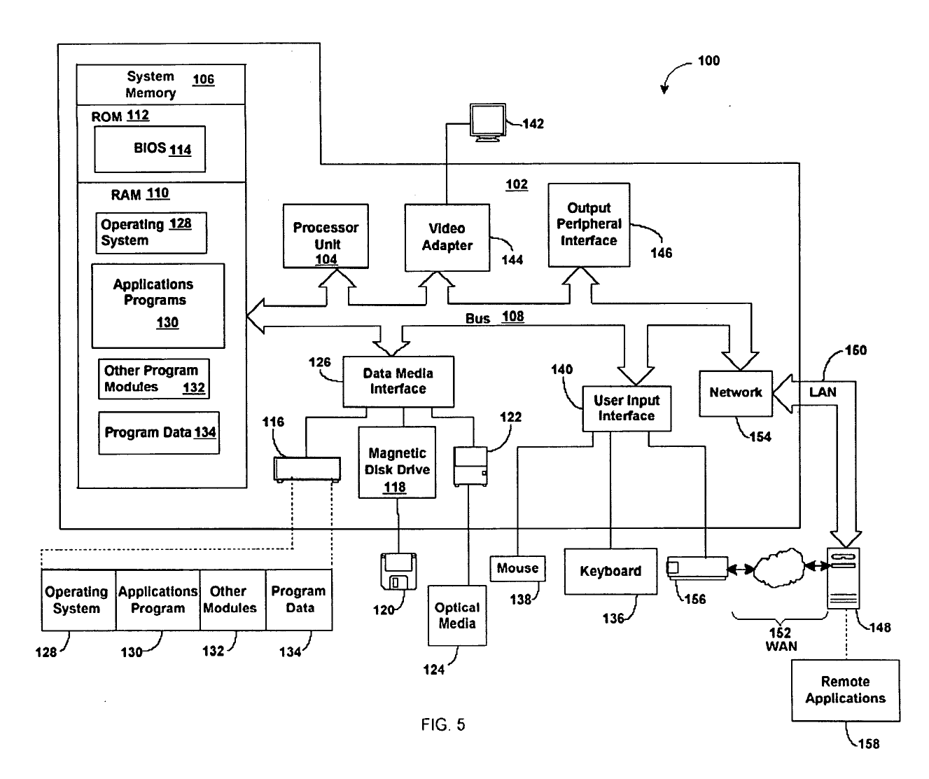

FIG. 5 shows a schematic of an exemplary computing environment 100 in which elements of the networking environment shown in FIG. 1 may operate. Computing environment 100 is only one example of a suitable computing environment and is not intended to suggest any limitation as to the scope of use or functionality of the approach described herein. Neither should computing environment 100 be interpreted as having any dependency or requirement relating to any one or combination of components illustrated in FIG. 5.

In computing environment 100 there is a computer 102, which is operational with numerous other general purpose or special purpose computing system environments or configurations. Examples of well known computing systems, environments, and/or configurations that may be suitable for use with computer 102 include, but are not limited to, personal computers, server computers, thin clients, thick clients, hand-held or laptop devices, multiprocessor systems, microprocessor-based systems, set top boxes, programmable consumer electronics, network PCs, minicomputers, mainframe computers, distributed computing environments that include any of the above systems or devices, and the like.

Exemplary computer 102 may be described in the general context of computer-executable instructions, such as program modules, being executed by a computer. Generally, program modules include routines, programs, objects, components, logic, data structures, and so on, which perform particular tasks or implements particular abstract data types. Computer 102 may be practiced in distributed computing environments where tasks are performed by remote processing devices that are linked through a communications network. In a distributed computing environment, program modules may be located in both local and remote computer storage media including memory storage devices.

As shown in FIG. 5, computer 102 in computing environment 100 is shown in the form of a general-purpose computing device. The components of computer 102 may include, but are not limited to, one or more processors or processing units 104, a system memory 106, and a bus 108 that couples various system components including the system memory 106 to processor 104.

Bus 108 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer 102 typically includes a variety of computer readable media. Such media may be any available media that is accessible by computer 102, and it includes both volatile and non-volatile media, removable and non-removable media.

In FIG. 5, system memory 106 includes computer readable media in the form of volatile memory, such as random access memory (RAM) 110, and/or non-volatile memory, such as ROM 112. A BIOS 114 containing the basic routines that help to transfer information between elements within computer 102, such as during start-up, is stored in ROM 112. RAM 110 typically contains data and/or program modules that are immediately accessible to and/or presently operated on by processor 104.

Computer 102 may further include other removable/non-removable, volatile/non-volatile computer storage media. By way of example only, FIG. 5 illustrates a hard disk drive 116 for reading from and writing to a non-removable, non-volatile magnetic media (not shown and typically called a “hard drive”), a magnetic disk drive 118 for reading from and writing to a removable, non-volatile magnetic disk 120 (e.g., a “floppy disk”), and an optical disk drive 122 for reading from or writing to a removable, non-volatile optical disk 124 such as a CD-ROM, DVD-ROM or other optical media. The hard disk drive 116, magnetic disk drive 118, and optical disk drive 122 are each connected to bus 108 by one or more data media interfaces 126.

The drives and their associated computer-readable media provide nonvolatile storage of computer readable instructions, data structures, program modules, and other data for computer 102. Although the exemplary environment described herein employs a hard disk 116, a removable magnetic disk 118 and a removable optical disk 122, it should be appreciated by those skilled in the art that other types of computer readable media which can store data that is accessible by a computer, such as magnetic cassettes, flash memory cards, digital video disks, RAMs, ROM, and the like, may also be used in the exemplary operating environment.

A number of program modules may be stored on hard disk 116, magnetic disk 120, optical disk 122, ROM 112, or RAM 110, including, by way of example, and not limitation, an operating system 128, one or more application programs 130, other program modules 132, and program data 134. Each of the operating system 128, one or more application programs 130, other program modules 132, and program data 134, or some combination thereof, may include an implementation of networking environment 10 of FIG. 1 including server array 14, virtual universe client 24 and benefit establishing tool 53. In one embodiment, the one or more application programs 130 include components of benefit establishing tool 53 such as linking component 80, benefit component 82, and transaction component 84.

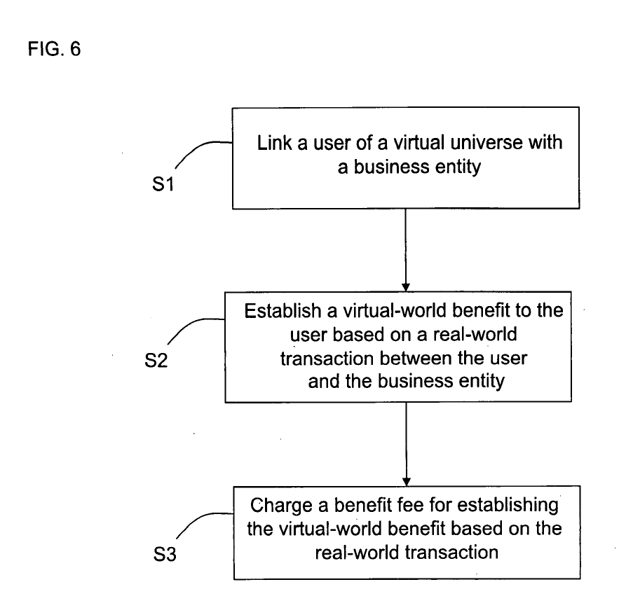

One or more program modules 130 carry out the methodologies disclosed herein, as shown in FIG. 6. According to one method, in step S1, a user of a virtual universe is linked with a business entity. In S2, a virtual universe benefit to the user based on a real-world transaction between the user and the business entity is established. In S3, a benefit fee is charged for establishing the virtual universe benefit based on the real-world transaction. The flowchart of FIG. 6 illustrates the architecture, functionality, and operation of possible implementations of systems, methods and computer program products according to various embodiments of the present invention. In this regard, each block in the flowchart may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently. It will also be noted that each block of flowchart illustration can be implemented by special purpose hardware-based systems that perform the specified functions or acts, or combinations of special purpose hardware and computer instructions.

Referring again to FIG. 5, a user may enter commands and information into computer 102 through optional input devices such as a keyboard 136 and a pointing device 138 (such as a “mouse”). Other input devices (not shown) may include a microphone, joystick, game pad, satellite dish, serial port, scanner, camera, or the like. These and other input devices are connected to processor unit 104 through a user input interface 140 that is coupled to bus 108, but may be connected by other interface and bus structures, such as a parallel port, game port, or a universal serial bus (USB).

An optional monitor 142 or other type of display device is also connected to bus 108 via an interface, such as a video adapter 144. In addition to the monitor, personal computers typically include other peripheral output devices (not shown), such as speakers and printers, which may be connected through output peripheral interface 146.

Computer 102 may operate in a networked environment using logical connections to one or more remote computers, such as a remote server/computer 148. Remote computer 148 may include many or all of the elements and features described herein relative to computer 102.

Logical connections shown in FIG. 5 are a local area network (LAN) 150 and a general wide area network (WAN) 152. Such networking environments are commonplace in offices, enterprise-wide computer networks, intranets, and the Internet. When used in a LAN networking environment, computer 102 is connected to LAN 150 via network interface or adapter 154. When used in a WAN networking environment, the computer typically includes a modem 156 or other means for establishing communications over WAN 152. The modem, which may be internal or external, may be connected to the system bus 108 via user input interface 140 or other appropriate mechanism.

In a networked environment, program modules depicted relative to computer 102, or portions thereof, may be stored in a remote memory storage device. By way of example, and not limitation, FIG. 5 illustrates remote application programs 158 as residing on a memory device of remote computer 148. It will be appreciated that the network connections shown and described are exemplary and other means of establishing a communications link between the computers may be used.

An implementation of exemplary computer 102 may be stored on or transmitted across some form of computer readable media. Computer readable media can be any available media that can be accessed by a computer. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media.

The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

It is apparent that there has been provided with this invention an approach for establishing a virtual universe benefit based on a real-world transaction. While the invention has been particularly shown and described in conjunction with a preferred embodiment thereof, it will be appreciated that variations and modifications will occur to those skilled in the art. Therefore, it is to be understood that the appended claims are intended to cover all such modifications and changes as fall within the true spirit of the invention.

What is claimed is:

1. A method for establishing a virtual universe benefit based on a real-world transaction, comprising:
linking a user of a virtual universe with a business entity; and
establishing a virtual universe benefit to the user based on a real-world transaction between the user and the business entity.

2. The method according to claim 1, the establishing comprising performing at least one of the following: adding a virtual product to an inventory of an avatar associated with the user, providing a credit to be redeemed by the avatar within the virtual universe, providing a currency reward to be used by the avatar within the virtual universe, providing an avatar augmentation, providing a message for the user, or providing access to a restricted portion of the virtual universe.

3. The method according to claim 2, the virtual product comprising a virtual representation of a real-world product.

4. The method according to claim 1, the business entity comprising at least one of the following: a credit card company, a vendor, or an organization.

5. The method according to claim 1 further comprising charging a benefit fee for establishing the virtual universe benefit based on the real-world transaction.

6. A computer system for establishing a virtual universe benefit based on a real-world transaction, comprising:
at least one processing unit;
memory operably associated with the at least one processing unit; and
a benefit establishing tool storable in memory and executable by the at least one processing unit, the benefit establishing tool comprising:
a linking component configured to link a user of a virtual universe with a business entity; and
a benefit component configured to establish a virtual universe benefit to the user based on a real-world transaction between the user and the business entity.

7. The benefit establishing tool according to claim 6, the benefit component further configured to perform at least one of the following: add a virtual product to an inventory of an avatar associated with the user, provide a credit to be redeemed by the avatar within the virtual universe, provide a currency reward to be used by the avatar within the virtual universe, provide an avatar augmentation, provide a message for the user, or provide access to a restricted portion of the virtual universe.

8. The benefit establishing tool according to claim 7, the virtual product comprising a virtual representation of a real-world product.

9. The benefit establishing tool according to claim 6, the business entity comprising at least one of the following: a credit card company, a vendor, or an organization.

10. The benefit establishing tool according to claim 6 further comprising a transaction component configured to charge a benefit fee for establishing the virtual universe benefit based on the real-world transaction.

11. A computer-readable medium storing computer instructions, which when executed, enables a computer system to establish a virtual universe benefit based on a real-world transaction, the computer instructions comprising:
linking a user of a virtual universe with a business entity; and
establishing a virtual universe benefit to the user based on a real-world transaction between the user and the business entity.

12. The computer-readable medium according to claim 11, the establishing comprising instructions for performing at least one of the following: adding a virtual product to an inventory of an avatar associated with the user, providing a credit to be redeemed by the avatar within the virtual universe, providing a currency reward to be used by the avatar within the virtual universe, providing an avatar augmentation, providing a message for the user, or providing access to a restricted portion of the virtual universe.

13. The computer-readable medium according to claim 12, the virtual product comprising a virtual representation of a real-world product.

14. The computer-readable medium according to claim 11, the business entity comprising at least one of the following: a credit card company, a vendor, or an organization.

15. The computer-readable medium according to claim 11 further comprising instructions for charging a benefit fee for establishing the virtual universe benefit based on the real-world transaction.

16. A method for deploying a benefit establishing tool for use in a computer system that establishes a virtual universe benefit based on a real-world transaction, comprising:
providing a computer infrastructure operable to:
link a user of a virtual universe with a business entity; and
establish a virtual universe benefit to the user based on a real-world transaction between the user and the business entity.

17. The computer infrastructure according to claim 16, the computer infrastructure operable to establish the virtual universe benefit operable to perform at least one of the following: add a virtual product to an inventory of an avatar associated with the user, provide a credit to be redeemed by the avatar within the virtual universe, provide a currency reward to be used by the avatar within the virtual universe, provide an avatar augmentation, provide a message for the user, or provide access to a restricted portion of the virtual universe.

18. The computer infrastructure according to claim 17, the virtual product comprising a virtual representation of a real-world product.

19. The computer infrastructure according to claim 16, the business entity comprising at least one of the following: a credit card company, a vendor, or an organization.

20. The computer infrastructure according to claim 16, the computer infrastructure further operable to charge a benefit fee for establishing the virtual universe benefit based on the real-world transaction.
